(19) United States
(12) Patent Application Publication
(10) Pub. No.: US 2024/0347257 A1
(43) Pub. Date: Oct. 17, 2024

(54) ELECTRONIC COMPONENT

(71) Applicant: Murata Manufacturing Co., Ltd., Nagaokakyo-shi (JP)

(72) Inventor: Shinya TACHIBANA, Nagaokakyo-shi (JP)

(21) Appl. No.: 18/738,436

(22) Filed: Jun. 10, 2024

Related U.S. Application Data
(63) Continuation of application No. PCT/JP2023/002061, filed on Jan. 24, 2023.

(30) Foreign Application Priority Data
Feb. 4, 2022 (JP) 2022-016417
May 2, 2022 (JP) 2022-076021

(51) Int. Cl. H01F 27/28; H01F 27/29

(52) U.S. Cl. CPC H01F 27/2804; H01F 27/292; H01F 2027/2809

(57) ABSTRACT

An electronic component includes an insulator, an inductor provided in the insulator and including a conductor pattern, and a first outer electrode electrically connected to the conductor pattern. The insulator includes a first main surface, a second main surface facing the first main surface, and a first side surface, a second side surface, a third side surface, and a fourth side surface connecting the first main surface and the second main surface to each other. A first outer electrode includes a first electrode provided along the first main surface and a second electrode provided along the first side surface. The electronic component further includes an internal conductor provided in the insulator and electrically connecting the first electrode and the second electrode.

### CROSS REFERENCE TO RELATED APPLICATIONS

This application claims the benefit of priority to Japanese Patent Application No. 2022-016417 filed on Feb. 4, 2022 and Japanese Patent Application No. 2022-076021 filed on May 2, 2022, and is a Continuation Application of PCT Application No. PCT/JP2023/002061 filed on Jan. 24, 2023. The entire contents of each application are hereby incorporated herein by reference.

### BACKGROUND OF THE INVENTION

### 1. Field of the Invention

The present disclosure relates to electronic components.

### 2. Description of the Related Art

Heretofore, a chip component type small electronic component in which an inductor (coil) is provided inside an insulator formed by laminating a plurality of insulator layers has been known. For example, Japanese Unexamined Patent Application Publication No. H9-246046 discloses a laminate type inductor configured of a multilayer body in which a plurality of magnetic sheets with coil conductors is laminated and outer electrodes to which the coil conductors are connected.

The electronic component disclosed in Japanese Unexamined Patent Application Publication No. H9-246046 includes a back surface electrode provided along a mounting surface placed on a mounting substrate and a side surface electrode provided along a side surface of the insulator as outer electrodes, the back surface electrode and the side surface electrode being electrically connected to each other. However, if the electrical connection between the back surface electrode and the side surface electrode is broken due to a defect, problems such as a significant change in the electrical characteristics of the electronic component may occur.

### SUMMARY OF THE INVENTION

Example embodiments of the present invention provide electronic components that are each able to reduce or prevent a change in electrical characteristics due to disconnection of an outer electrode.

An electronic component according to an example embodiment of the present invention includes an insulator, an inductor, and an outer electrode. The inductor is provided in the insulator and includes a first conductor pattern. The outer electrode is electrically connected to the first conductor pattern. The insulator includes a first main surface, a second main surface facing the first main surface, and a first side surface, a second side surface, a third side surface, and a fourth side surface connecting the first main surface and the second main surface to one another. The first side surface faces the second side surface. The third side surface faces the fourth side surface. The outer electrode includes a first electrode provided along the first main surface and a second electrode provided along the first side surface. The electronic component includes an internal conductor provided in the insulator and electrically connecting the first electrode and the second electrode.

According to example embodiments of the present invention, even if the electrical connection between the first electrode provided along the first main surface and the second electrode provided along the first side surface is broken, the electrical connection between the first electrode and the second electrode can be maintained by the internal conductor provided in the insulator. Thus, a change in electrical characteristics due to the disconnection of the outer electrode can be reduced or prevented.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of an electronic component according to Example Embodiment 1 of the present invention.

FIG. 2 is a cross-sectional view illustrating the configuration of the inside of an insulator of the electronic component according to Example Embodiment 1 of the present invention.

FIG. 3 is an exploded plan view illustrating the configuration of the electronic component according to Example Embodiment 1 of the present invention.

FIGS. 4A and 4B are cross-sectional views and an equivalent circuit diagram illustrating the electrical connection of a first outer electrode of the electronic component according to Example Embodiment 1 of the present invention.

FIGS. 5A and 5B are cross-sectional views and an equivalent circuit diagram illustrating the electrical connection of the first outer electrode of the electronic component according to Example Embodiment 1 of the present invention.

FIG. 6 is a diagram for describing magnetic field coupling in the electronic component according to Example Embodiment 1 of the present invention.

FIG. 7 is a diagram illustrating the result of comparison of inductance values between the electronic component according to Example Embodiment 1 of the present invention and an electronic component according to a comparative example.

FIGS. 8A and 8B are cross-sectional views and an equivalent circuit diagram illustrating the configuration of the inside of an insulator of an electronic component according to Example Embodiment 2 of the present invention.

FIG. 9 is an exploded plan view illustrating the configuration of the electronic component according to Example Embodiment 2 of the present invention.

FIG. 10 is a cross-sectional view illustrating the configuration of the inside of an insulator of an electronic component according to Example Embodiment 3 of the present invention.

FIG. 11 is an exploded plan view illustrating the configuration of the electronic component according to Example Embodiment 3 of the present invention.

FIG. 12 is an equivalent circuit diagram of the electronic component according to Example Embodiment 3 of the present invention.

FIG. 13 is a perspective view of an electronic component according to Example Embodiment 4 of the present invention.

FIG. 14 is a cross-sectional view illustrating the configuration of the inside of an insulator of the electronic component according to Example Embodiment 4 of the present invention.

FIG. 15 is an exploded plan view illustrating the configuration of the electronic component according to Example Embodiment 4 of the present invention.

FIG. 16 is an equivalent circuit diagram of the electronic component according to Example Embodiment 4 of the present invention.

FIGS. 17A and 17B are diagrams for describing displacement of a conductor pattern of an electronic component according to a comparative example.

FIGS. 18A and 18B are diagrams for describing displacement of a conductor pattern of the electronic component according to Example Embodiment 4 of the present invention.

### DETAILED DESCRIPTION OF THE EXAMPLE EMBODIMENTS

Hereinafter, filter devices according to example embodiments of the present invention will be described in detail with reference to the drawings. The same or corresponding portions and elements in the drawings are denoted by the same reference signs and descriptions thereof are not repeated.

### Example Embodiment 1

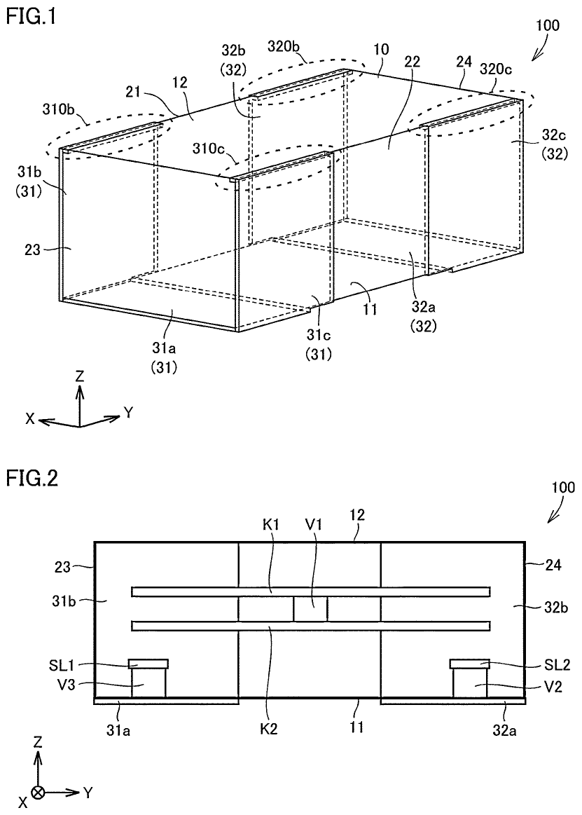

An electronic component 100 according to Example Embodiment 1 of the present invention will be described with reference to FIGS. 1 to 7. FIG. 1 is a perspective view of the electronic component 100 according to Example Embodiment 1. In

FIG. 1, the short side direction of the electronic component 100 is the X direction, the long side direction thereof is the Y direction, and the height direction thereof is the Z direction.

The electronic component 100 according to Example Embodiment 1 is a chip component small coil including at least one conductor pattern. The electronic component 100 includes a rectangular or substantially rectangular parallelepiped insulator 10 in which a plurality of insulating substrates (insulator layers) with at least one conductor pattern provided is laminated. The lamination direction of the insulating substrates is the Z direction, and the arrow direction indicates the upper layer direction in FIG. 1. For example, the insulating substrate is made of an insulating material mainly including borosilicate glass, or an insulating resin such as alumina, zirconia, and polyimide resin. Further, in the insulator 10, there are cases where interfaces between the plurality of insulating substrates are not distinct due to processes such as firing and solidification, for example.

The insulator 10 includes a first main surface 11, a second main surface 12 facing the first main surface 11, a first side surface 21, a second side surface 22, a third side surface 23, and a fourth side surface 24 connecting the first main surface 11 and the second main surface 12 to one another.

In FIG. 1, the first main surface 11 is located below the second main surface 12 in the Z direction. The first main surface 11 is a mounting surface disposed on a mounting substrate, and when the electronic component 100 is mounted on the mounting substrate, the first main surface 11 faces the mounting substrate. In Example Embodiment 1, the first main surface 11 is also referred to as a bottom surface or a back surface and the second main surface 12 is also referred to as a top surface.

The first side surface 21 and the second side surface 22 are provided in the longitudinal direction (Y direction) of the insulator 10. The first side surface 21 faces the second side surface 22. The third side surface 23 and the fourth side surface 24 are provided in the lateral direction (X direction) of the insulator 10. The third side surface 23 faces the fourth side surface 24.

The electronic component 100 includes a first outer electrode 31 and a second outer electrode 32 electrically connected to at least one conductor pattern provided inside the insulator 10. The first outer electrode 31 is provided on the third side surface 23 side of the second outer electrode 32 in the longitudinal direction (Y direction) of the insulator 10. The second outer electrode 32 is provided on the fourth side surface 24 side of the first outer electrode 31 in the longitudinal direction (Y direction) of the insulator 10.

The first outer electrode 31 and the second outer electrode 32 are not limited to the first main surface 11 which is the bottom surface of the insulator 10. Electrodes (e.g., electrode surfaces) are also provided on the first side surface 21 and the second side surface 22 connecting the first main surface 11 and the second main surface 12.

Specifically, the first outer electrode 31 includes a first electrode 31a provided along the first main surface 11, a second electrode 31b provided along the first side surface 21, and a third electrode 31c provided along the second side surface 22. The second electrode 31b and the third electrode 31c are electrically connected to the first electrode 31a by a path along the outer periphery of the insulator 10. That is, the first electrode 31a, the second electrode 31b, and the third electrode 31c are designed to be at the same potential by being electrically connected by a path along the outer periphery of the insulator 10.

Moreover, the first outer electrode 31 does not include electrodes along the second main surface 12, the third side surface 23, and the fourth side surface 24. That is, when the first outer electrode 31 is viewed from the third side surface 23 side with the first main surface 11 on the lower side (mounting substrate side), the first outer electrode 31 has a recessed shape (for example, U shape) or a substantially recessed shape (for example, substantial U shape). Strictly speaking, an end portion 310b of the second electrode 31b provided along the first side surface 21 and an end portion 310c of the third electrode 31c provided along the second side surface 22 hang from the second main surface 12, but the end portions 310b and 310c are not directly connected to the conductor pattern in the insulator 10. The first outer electrode 31 may be provided in the insulator 10 so that the end portions 310b and 310c do not hang on the second main surface 12.

The second outer electrode 32 includes a fourth electrode 32a provided along the first main surface 11, a fifth electrode 32b provided along the first side surface 21, and a sixth electrode 32c provided along the second side surface 22. The fifth electrode 32b and the sixth electrode 32c are electrically connected to the fourth electrode 32a by a path along the outer periphery of the insulator 10. That is, the fourth electrode 32a, the fifth electrode 32b, and the sixth electrode 32c are configured to be at the same potential by being electrically connected by a path along the outer periphery of the insulator 10.

Moreover, the second outer electrode 32 does not include electrodes along the second main surface 12, the third side surface 23, and the fourth side surface 24. That is, when the second outer electrode 32 is viewed from the fourth side surface 24 side with the first main surface 11 on the lower side (mounting substrate side), the second outer electrode 32 has a recessed shape (for example, U shape) or a substantially recessed shape (for example, substantial U shape). Strictly speaking, an end portion 320b of the fifth electrode 32b provided along the first side surface 21 and an end portion 320c of the sixth electrode 32c provided along the second side surface 22 hang on the second main surface 12, but the end portions 320b and 320c are not directly connected to the conductor pattern in the insulator 10. The second outer electrode 32 may be provided in the insulator 10 so that the end portions 320b and 320c do not hang on the second main surface 12.

While the first outer electrode 31 and the second outer electrode 32 includes electrodes on both of the first side surface 21 and the second side surface 22, the first outer electrode 31 and the second outer electrode 32 may include an electrode on just one of the first side surface 21 and the second side surface 22. That is, when the first outer electrode 31 and the second outer electrode 32 are viewed from the third side surface 23 side or the fourth side surface 24 side with the first main surface 11 on the lower side (mounting substrate side), the first outer electrode 31 and the second outer electrode 32 may have, for example, an L shape or a substantial L shape.

Alternatively, the first outer electrode 31 and the second outer electrode 32 may include an electrode on the third side surface 23 and the fourth side surface 24.

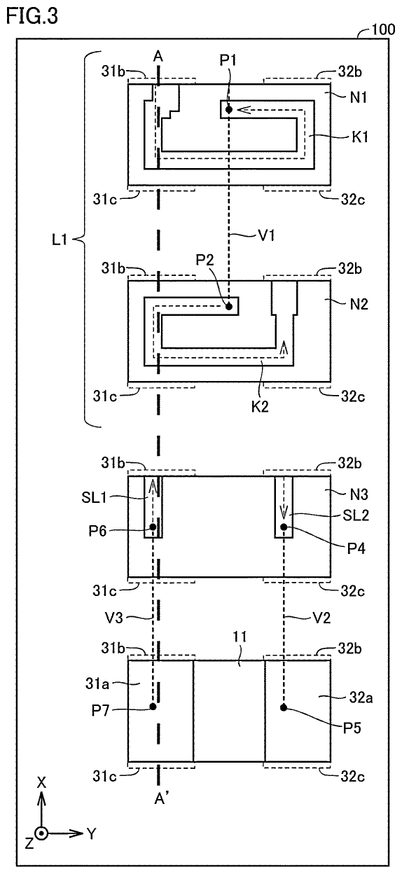

FIG. 2 is a cross-sectional view illustrating the configuration of the inside of the insulator 10 of the electronic component 100 according to Example Embodiment 1. FIG. 3 is an exploded plan view illustrating the configuration of the electronic component 100 according to Example Embodiment 1. As illustrated in FIGS. 2 and 3, the electronic component 100 includes, in the insulator 10, an inductor L1 including conductor patterns K1 and K2. In the electronic component 100 according to Example Embodiment 1, the conductor pattern K2 is one example of “first conductor pattern”. The conductor patterns K1 and K2 of the inductor L1 are superimposed parallel or substantially parallel to the first main surface 11 of the insulator 10, and are electrically connected to each other by a via conductor V1.

Specifically, as illustrated in FIG. 3, the electronic component 100 includes insulating substrates N1 to N3 in this order from the second main surface 12 side. In the insulator 10, the conductor pattern and the electrode pattern are provided on the insulating substrates N1 to N3 by, for example, a printing method.

The conductor pattern K1 as a portion of the inductor L1 is provided on the insulating substrate N1. The conductor pattern K1 is structured so as to make a leftward turn from the upper left side of the insulating substrate N1 in FIG. 3. The beginning of the conductor pattern K1 is electrically connected to the second electrode 31b of the first outer electrode 31. A connection portion P1 that connects to the via conductor V1 is provided in the vicinity of the end of the conductor pattern K1.

The conductor pattern K2 as a portion of the inductor L1 is provided on the insulating substrate N2. The conductor pattern K2 is structured so as to make a leftward turn from the center of the upper side of the insulating substrate N2 in FIG. 3. A connection portion P2 that connects to the via conductor V1 is provided in the vicinity of the beginning of the conductor pattern K2. The end of the conductor pattern K2 is electrically connected to the fifth electrode 32b of the second outer electrode 32.

As described above, the inductor L1 defines a coil by series connection of the conductor pattern K1 and the conductor pattern K2.

The inductor L1 is not limited to the case of defining a coil including the two conductor patterns of the conductor pattern K1 and the conductor pattern K2, and may define a coil including three or more conductor patterns.

Thus, in the insulator 10 of the electronic component 100, the conductor patterns K1 and K2 are electrically connected to the second electrode 31b of the first outer electrode 31 and the fifth electrode 32b of the second outer electrode 32 via the via conductors V1 and V2.

When providing an inductor conductor pattern across a plurality of layers, if only the first electrode 31a or the fourth electrode 32a on the first main surface 11 is used, a via conductor needs to be provided across the plurality of layers, and it is necessary to reduce the cavity of the inductor L1 or increase the size of the electronic component without changing the cavity of the inductor L1. However, if electrodes are also provided on the first side surface 21 and the second side surface 22 of the insulator 10 in addition to the first electrode 31a and the fourth electrode 32a on the first main surface 11 as in the electronic component 100 according to Example Embodiment 1, the inductor conductor pattern can also be connected to the first side surface 21 and the second side surface 22 without using vias. As a result, in the electronic component 100, the conductor pattern can be provided as large as possible within the outer frame of the insulator 10. Further, since the first side surface 21 and the second side surface 22 are at the same potential, the inductor conductor pattern can be connected at two portions on the side surface. By configuring the side surface electrode in this way, the length of the conductor pattern can be easily adjusted, and the degree of freedom in the design of the conductor pattern can be improved.

Here, as described above, the second electrode 31b and the third electrode 31c are electrically connected to the first electrode 31a by a path along the outer periphery of the insulator 10. However, if the electrical connection between the first electrode 31a and the second electrode 31b or the third electrode 31c is broken due to a defect, problems such as a significant change in the electrical characteristics of the electronic component 100 may occur.

In view of this, the electronic component 100 according to Example Embodiment 1 further includes an internal conductor SL1 provided in the insulator 10 and electrically connecting the first electrode 31a and the second electrode 31b. While the internal conductor SL1 of the present example embodiment is a bypass conductor connecting the first electrode 31a and the second electrode 31b, the internal conductor SL1 does not have to be a bypass conductor as long as it is configured to electrically connect the first electrode 31a and the second electrode 31b.

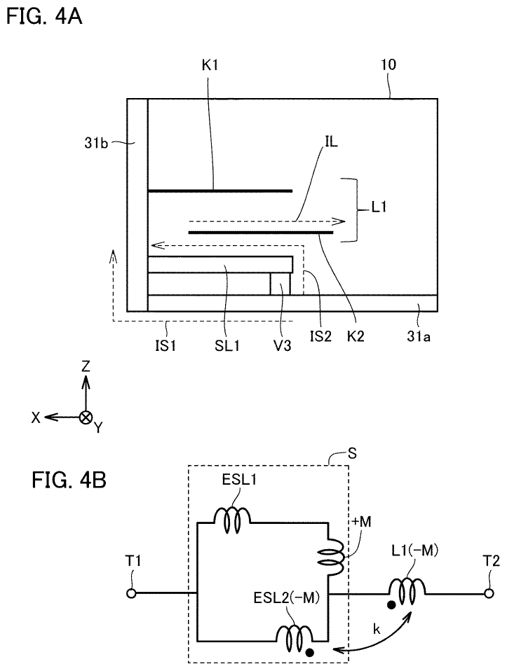

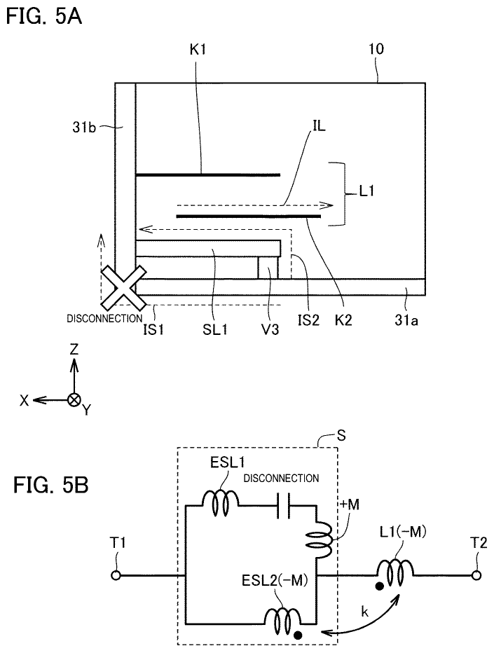

Moreover, the electronic component 100 according to Example Embodiment 1 further includes an internal conductor SL2 provided in the insulator 10 and electrically connecting the fourth electrode 32a and the fifth electrode 32b. While the internal conductor SL2 of the present example embodiment is a bypass conductor connecting the fourth electrode 32a and the fifth electrode 32b, the internal conductor SL2 does not have to be a bypass conductor as long as it is configured to electrically connect the fourth electrode 32a and the fifth electrode 32b. Hereinafter, while the internal conductor SL1 will mainly be described with reference to FIGS. 4A and 4B and FIGS. 5A and 5B in addition to FIG. 3, the internal conductor SL2 defines and functions similarly to the internal conductor SL1.

FIGS. 4A and 4B and FIGS. 5A and 5B are cross-sectional views and equivalent circuit diagrams illustrating the electrical connection of the first outer electrode 31 of the electronic component 100 according to Example Embodiment 1. FIGS. 4A and 4B and FIGS. 5A and 5B are diagrams in which an A-A′ section of the electronic component 100 illustrated in FIG. 3 is viewed in the Y direction from the third side surface 23 side.

As illustrated in FIGS. 3 to 5B, the internal conductor SL1 is provided in the insulating substrate N3. The internal conductor SL1 is configured so as to extend from the substantial center portion of the short side direction (X direction) of the insulating substrate N3 to the second electrode 31b, in the vicinity of the second electrode 31b and the third electrode 31c on the third side surface 23 side. In addition, the internal conductor SL1 extends in the same direction (X direction) as a portion of the conductor pattern K2 of the inductor L1. In plan view of the internal conductor SL1 viewed from the second main surface 12 side, the internal conductor SL1 is provided in a position overlapping a portion of the conductor pattern K2 in the lamination direction (Z direction).

The internal conductor SL1 is electrically connected to the second electrode 31b. The internal conductor SL1 is provided with a connection portion P6 that connects to a via conductor V3. The connection portion P6 of the internal conductor SL1 is connected to a connection portion P7 provided in the first electrode 31a by the via conductor V3.

With this configuration, the first electrode 31a and the second electrode 31b are electrically connected by a first path (i.e., path along first main surface 11 and first side surface 21) through the outer periphery of the insulator 10, and are also electrically connected by a second path passing through the via conductor V3 and the internal conductor SL1 inside the insulator 10.

Moreover, as illustrated in FIG. 3, the internal conductor SL2 is provided in the insulating substrate N3. The internal conductor SL2 is provided so as to extend from the substantial center portion of the short side direction (X direction) of the insulating substrate N3 to the fifth electrode 32b, in the vicinity of the fifth electrode 32b and the sixth electrode 32c on the fourth side surface 24 side. In addition, the internal conductor SL2 extends in the same direction (X direction) as a part of the conductor pattern K2 of the inductor L1. In plan view of the internal conductor SL2 viewed from the second main surface 12 side, the internal conductor SL2 is provided in a position overlapping a part of the conductor pattern K2 in the lamination direction (Z direction).

The internal conductor SL2 is electrically connected to

the fifth electrode 32b. The internal conductor SL2 is provided with a connection portion P4 that connects to a via conductor V2. The connection portion P4 of the internal conductor SL2 is connected to a connection portion P5 provided in the fourth electrode 32a by the via conductor V2.

With this configuration, the fourth electrode 32a and the fifth electrode 32b are electrically connected by a first path (i.e., path along first main surface 11 and first side surface 21) through the outer periphery of the insulator 10, and are also electrically connected by a second path passing through the via conductor V2 and the internal conductor SL2 inside the insulator 10.

As illustrated in FIG. 4A, a current IL flows through the conductor pattern K2. In the first path passing through the outer periphery of the insulator 10, a current IS1 flows along the outer periphery from the first electrode 31a to the second electrode 31b. In a second path passing through the internal conductor SL1 in the insulator 10, a current IS2 flows from the first electrode 31a to the second electrode 31b via the via conductor V3 and the internal conductor SL1. The current IS2 flowing through the internal conductor SL1 is parallel and opposite to the current IL flowing through the part of the conductor pattern K2 adjacent to the internal conductor SL1. The internal conductor SL1 and the conductor pattern K2 are in magnetic field coupling (coupling coefficient k) with each other. Specifically, the internal conductor SL1 is in magnetic field coupling (subtractive polarity coupling) with the conductor pattern K2 so that the polarity of the internal conductor SL1 is opposite to that of the conductor pattern K2.

Although not illustrated in FIG. 4A, in the first path passing through the outer periphery of the insulator 10, a current IS1′ flows along the outer periphery from the fifth electrode 32b to the fourth electrode 32a. In the second path passing through the internal conductor SL2 in the insulator 10, a current IS2′ flows from the fifth electrode 32b to the fourth electrode 32a via the internal conductor SL2 and the via conductor V2. The current IS2′ flowing through the internal conductor SL2 is parallel or substantially parallel and opposite to the current IL flowing through the portion of the conductor pattern K2 adjacent to the internal conductor SL2. The internal conductor SL2 and the conductor pattern K2 are in magnetic field coupling (coupling coefficient k) with each other. Specifically, the internal conductor SL2 is in magnetic field coupling (subtractive polarity coupling) with the conductor pattern K2 so that the polarity of the internal conductor SL2 is opposite to that of the conductor pattern K2.

As illustrated in FIG. 4B, the electronic component 100 includes a first terminal T1 corresponding to a connection point in the mounting substrate of the first outer electrode 31, a second terminal T2 corresponding to a connection point in the mounting substrate of the second outer electrode 32, and the inductor L1 located between the first terminal T1 and the second terminal T2. The inductor L1 is connected to the second terminal T2. In addition, the electronic component 100 includes a parasitic inductance ESL1 and a parasitic inductance ESL2 connected in parallel between first terminal T1 and inductor L1. The parasitic inductance ESL1 occurs at the first electrode 31a and the second electrode 31b where the current IS1 flows. The parasitic inductance ESL2 occurs at the internal conductor SL1 where the current IS2 flows.

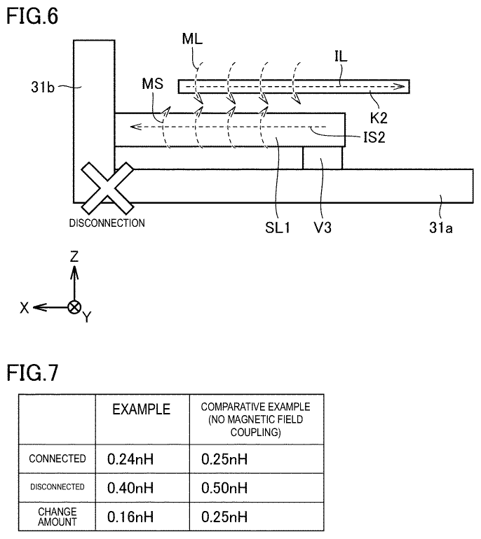

The conductor pattern K2 of the inductor L1 and the internal conductor SL1 are in magnetic field coupling (coupling coefficient k) with each other. FIG. 6 is a diagram for describing magnetic field coupling in the electronic component 100 according to Example Embodiment 1. As illustrated in FIG. 6, in the conductor pattern K2, a magnetic field ML is generated by the current IL. In addition, in the internal conductor SL1, a magnetic field MS is generated by the current IS2 flowing parallel or substantially parallel and opposite to the current IL. Mutual inductance M occurs between the conductor pattern K2 and the internal conductor SL1 due to magnetic field coupling between the magnetic field ML generated in the conductor pattern K2 and the magnetic field MS generated in the internal conductor SL1. FIG. 4B illustrates an equivalent circuit diagram with mutual inductance −M added to each of the conductor pattern K2 and the internal conductor SL1, and mutual inductance +M added between the parasitic inductance ESL1 and the inductor L1 and the parasitic inductance ESL2, taking into account the mutual inductance M that is generated.

As described above, in the electronic component 100, the first electrode 31a and the second electrode 31b are electrically connected by the first path passing through the outer periphery of the insulator 10, and also by the second path passing through the internal conductor SL1 in the insulator 10. As a result, as illustrated in FIGS. 5A and 5B, even if the electrical connection between the first electrode 31a and the second electrode 31b is broken in the first path passing through the outer periphery of the insulator 10, the electrical connection between the first electrode 31a and the second electrode 31b is maintained in the second path passing through the internal conductor SL1 in the insulator 10. This can reduce or prevent a change in electrical characteristics due to disconnection of the first outer electrode 31.

One example of the change in electrical characteristics will be described with reference to FIG. 7. FIG. 7 is a diagram illustrating the result of comparison of inductance values between the electronic component 100 according to Example Embodiment 1 and an electronic component according to a comparative example. FIG. 7 shows the characteristic change when the electronic component 100 according to Example Embodiment 1 is used as an electronic component according to an example, and the characteristic change when an electronic component with the same internal conductor SL1 as the electronic component 100 according to Example Embodiment 1 but without magnetic field coupling is used as an electronic component according to the comparative example. While the parasitic inductance is compared by focusing only on the internal conductor SL1 in this example, the internal conductor SL2 can achieve an effect similar to the internal conductor SL1. The characteristic change is the change in inductance value in a portion between the first terminal T1 and the inductor L1 (ESL unit S indicated by dashed line in FIGS. 4B and 5B). In the comparative example, the parasitic inductance ESL1 and parasitic inductance ESL2 are set to about 0.5 nH and the mutual inductance M is set to about 0.1 nH.

As shown in FIG. 7, in the case of the example, the inductance value of the ESL unit S is about 0.24 nH when the first electrode 31a and the second electrode 31b are electrically connected in the first path passing through the outer periphery of the insulator 10, whereas the inductance value of the ESL unit S when the first electrode 31a and the second electrode 31b are disconnected is about 0.40 nH. Thus, the amount of change is about 0.16 nH.

In the case of the comparative example, the inductance value of the ESL unit S is about 0.25 nH when the first electrode 31a and the second electrode 31b are electrically connected in the first path passing through the outer periphery of the insulator 10, whereas the inductance value of the ESL unit S when the first electrode 31a and the second electrode 31b are disconnected is about 0.50 nH. Thus, the amount of change is about 0.25 nH.

In the electronic component according to the comparative example, if the electrical connection between first electrode 31a and second electrode 31b is disconnected, the path in the ESL unit S is ESL2 alone, so the inductance value of the ESL unit S increases. However, in the electronic component 100 according to Example Embodiment 1, due to the magnetic field coupling (subtractive polarity coupling) between the internal conductor SL1 and the conductor pattern K2 (one example of first conductor pattern), the amount of current IS2 flowing through ESL2 increases, resulting in a larger mutual inductance M. Therefore, the amount of increase in the inductance value of the ESL unit S, expressed as ESL2−M, can be reduced or prevented. Accordingly, the electronic component 100 corresponding to the example can reduce the amount of change in the inductance value of the ESL unit S more than the comparative example.

As described above, in the electronic component 100 according to Example Embodiment 1, even when the electrical connection between the first electrode 31a and the second electrode 31b is broken, the internal conductor SL1 provided in the insulator 10 can maintain the electrical connection between the first electrode 31a and the second electrode 31b. Furthermore, the magnetic field coupling between the internal conductor SL2 and the conductor pattern K2 increases the mutual inductance according to an increase in the current flowing through the internal conductor SL2 due to the disconnection. Thus, a change in electrical characteristics due to disconnection of the first outer electrode 31 can be reduced or prevented even more.

The internal conductor SL1 is not limited to electrically connecting the first electrode 31a and the second electrode 31b, and may be provided in the insulator 10 to electrically connect the first electrode 31a and the third electrode 31c.

Moreover, the internal conductor SL1 does not have to be provided in a position overlapping a portion of the conductor pattern K2 in plan view of the internal conductor SL1 when viewed from the second main surface 12 side. The internal conductor SL1 may be provided in any position as long as it is in magnetic field coupling with the conductor pattern K2.

Furthermore, the current IS2 flowing through the internal conductor SL1 does not have to be parallel or substantially parallel to the current IL flowing through the conductor pattern K2, and the internal conductor SL1 may be arranged in a non-parallel manner for magnetic field coupling with the conductor pattern K2.

### Example Embodiment 2

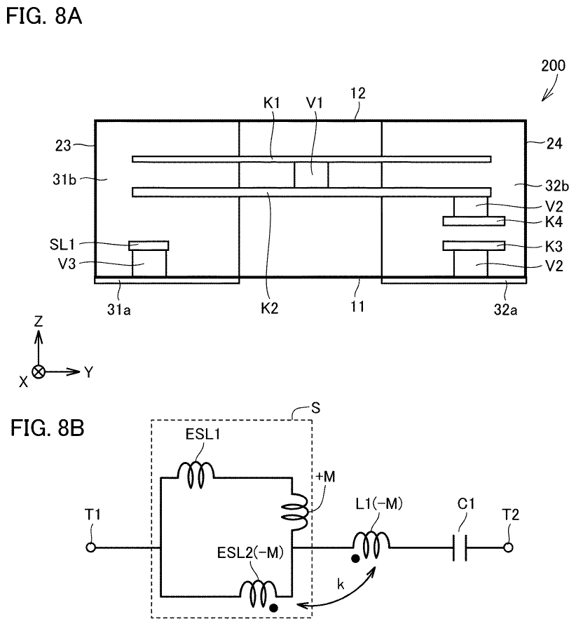

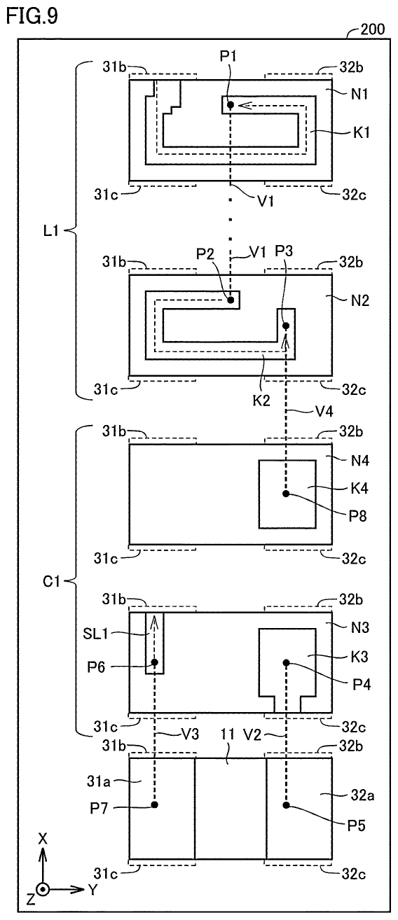

An electronic component 200 according to Example Embodiment 2 of the present invention will be described with reference to FIGS. 8A and 8B and 9. In Example Embodiment 2, a chip component small filter device in which an inductor L1 and a capacitor C1 are connected in series will be described as the electronic component 200. For the electronic component 200 according to Example Embodiment 2, only configurations different from the electronic component 100 according to Example Embodiment 1 will be described, and the same or substantially the same configurations as the electronic component 100 according to Example Embodiment 1 are denoted by the same reference signs in the electronic component 200 according to Example Embodiment 2, and descriptions thereof are omitted.

FIGS. 8A and 8B are cross-sectional views and an equivalent circuit diagram illustrating the configuration in an insulator 10 of the electronic component 200 according to Example Embodiment 2. FIG. 9 is an exploded perspective view illustrating the configuration of the electronic component 200 according to Example Embodiment 2. As illustrated in FIGS. 8A and 8B and 9, the electronic component 200 includes, in the insulator 10, an inductor L1 including conductor patterns K1 and K2, and a capacitor C1 including electrode patterns K3 and K4. By connecting the inductor L1 and the capacitor C1 in series in the insulator 10, the electronic component 200 defines a series resonant circuit. In the electronic component 200 according to Example Embodiment 2, the conductor pattern K2 is one example of “first conductor pattern”.

The electrode patterns K3 and K4 of the capacitor C1 are superimposed on each other with an insulating layer interposed therebetween below the conductor patterns K1 and K2 of the inductor L1 in the Z direction. That is, the capacitor C1 is provided on a first main surface 11 side of the inductor L1. In plan view of the capacitor C1 viewed from a second main surface 12 side, the electrode patterns K3 and K4 of the capacitor C1 are provided in a position overlapping a portion of the conductor patterns K1 and K2 in the lamination direction (Z direction).

As illustrated in FIG. 9, the electronic component 200 further includes an insulating substrate N4 between an insulating substrate N2 and an insulating substrate N3. The electrode pattern K4 defining one electrode of the capacitor C1 is provided on the insulating substrate N4. In plan view of the electrode pattern K4 viewed from the second main surface 12 side, the electrode pattern K4 is provided in a position overlapping a portion of the conductor patterns K1 and K2 in the lamination direction (Z direction). That is, the electrode pattern K4 is provided in a position where the region overlapping the cavity of an inductor L1 including the conductor patterns K1 and K2 is reduced. A connection portion P8 that connects to a via conductor V4 is provided in the electrode pattern K4. That is, the electrode pattern K4 is connected to a connection portion P3 of the conductor pattern K2 of the inductor L1 by the via conductor V4.

An electrode pattern K3 defining the other electrode of the capacitor C1 is provided on the insulating substrate N3. In plan view of the electrode pattern K3 viewed from the second main surface 12 side, the electrode pattern K3 is provided in a position overlapping a portion of the conductor patterns K1 and K2 in the lamination direction (Z direction). That is, the electrode pattern K3 is provided in a position where the region overlapping the cavity of the inductor L1 including the conductor patterns K1 and K2 is reduced. A connection portion P4 of the electrode pattern K3 is connected to a connection portion P5 provided in a fourth electrode 32a by a via conductor V2.

The electrode pattern K3 is electrically connected to a sixth electrode 32c of a second outer electrode 32. A path from the connection portion P5 provided in the fourth electrode 32a to the sixth electrode 32c of the second outer electrode 32 via the via conductor V2 and the electrode pattern K3 corresponds to the path in the electronic component 100 according to Example Embodiment 1 from the connection portion P5 provided in the fourth electrode 32a to the fifth electrode 32b of the second outer electrode 32 via the via conductor V2 and the internal conductor SL2.

As described above, not only a chip component small coil including the inductor L1, but also a chip component small filter device that defines a resonant circuit such as the electronic component 200 according to Example Embodiment 2 may electrically connect a first electrode 31a and a second electrode 31b by an internal conductor SL1 provided in the insulator 10.

Specifically, in the electronic component 200, the internal conductor SL1 is provided on the same insulating substrate N3 as the electrode pattern K3 defining the capacitor C1. The internal conductor SL1 is provided at a position overlapping a portion of the conductor pattern K2 in the lamination direction (Z direction) and extends in the same direction (X direction) as a portion of the conductor pattern K2 of the inductor L1. The current flowing through the internal conductor SL1 is parallel or substantially parallel and opposite to the current flowing through the portion of the conductor pattern K2 adjacent to the internal conductor SL1. The internal conductor SL1 and the conductor pattern K2 are in magnetic field coupling (subtractive polarity coupling) with each other.

As a result, in a filter device that defines an LC series circuit, as well, even if the electrical connection between the first electrode 31a and the second electrode 31b is broken in a first path passing through the outer periphery of the insulator 10, the electrical connection between the first electrode 31a and the second electrode 31b is maintained in a second path passing through the internal conductor SL1 in the insulator 10. Therefore, a change in electrical characteristics due to the disconnection of the first outer electrode 31 can be reduced or prevented.

In the case of a filter using series resonance, the series resonance frequency is designed as the pass frequency, so if the inductance value of an ESL unit S changes due to the disconnection of the first path of the first electrode 31a and the second electrode 31b, the pass band will deviate from the design. Therefore, by providing the internal conductor SL1, the change in inductance value regarding the first outer electrode 31 can be curbed, and the change in the filter characteristics can be reduced or prevented.

### Example Embodiment 3

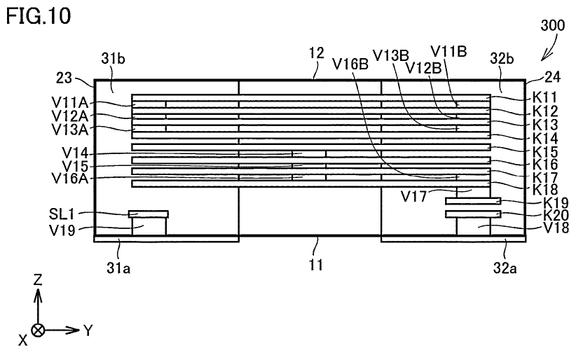

An electronic component 300 according to Example Embodiment 3 of the present invention will be described with reference to FIGS. 10 to 12. In Example Embodiment 3, a chip component small filter device in which an inductor L12 and a capacitor C11 are connected in series and the inductor L12 and the capacitor C11 are connected in parallel with an inductor L11 will be described as the electronic component 300. For the electronic component 300 according to Example Embodiment 3, only configurations different from the electronic component 100 according to Example Embodiment 1 and the electronic component 200 according to Example Embodiment 2 will be described, and the same or substantially the same configurations as the electronic component 100 according to Example Embodiment 1 and the electronic component 200 according to Example Embodiment 2 are denoted by the same reference signs in the electronic component 300 according to Example Embodiment 3, and descriptions thereof are omitted.

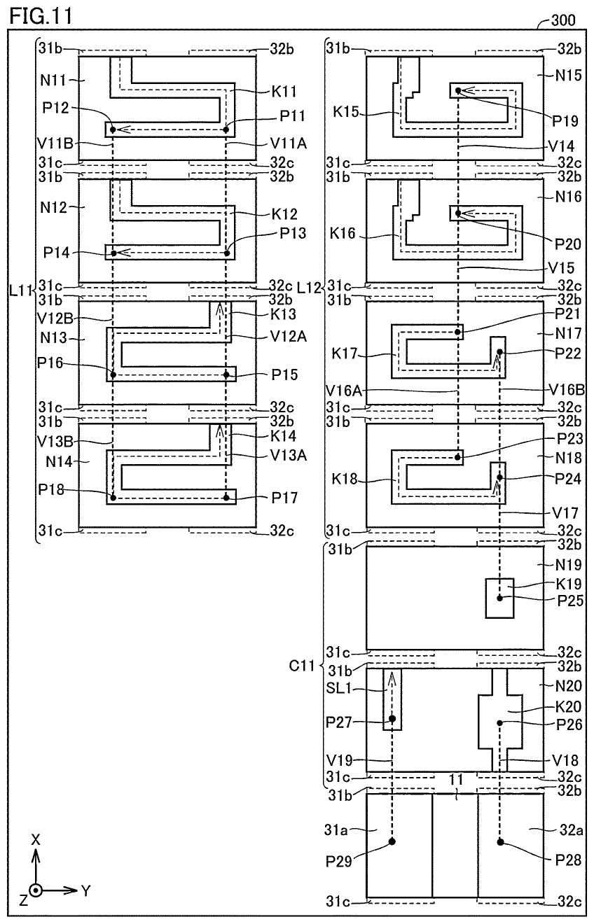

FIG. 10 is a cross-sectional view illustrating the configuration in an insulator 10 of the electronic component 300 according to Example Embodiment 3. FIG. 11 is an exploded perspective view illustrating the configuration of the electronic component 300 according to Example Embodiment 3. As illustrated in FIGS. 10 and 11, the electronic component 300 includes, in the insulator 10, the inductor L11 configured of conductor patterns K11 to K14, the inductor L12 including conductor patterns K15 to K18, and the capacitor C11 including electrode patterns K19 and K20. By connecting the inductor L12 and the capacitor C11 in series and connecting the inductor L12 and the capacitor C11 in parallel with the inductor L11 in the insulator 10, the electronic component 300 defines a resonant circuit. In the electronic component 300 according to Example Embodiment 3, the conductor pattern K18 is one example of “first conductor pattern”. In addition, in the electronic component 300 according to Example Embodiment 3, the inductor L12 is one example of “inductor”, and the inductor L11 is one example of “another inductor”.

The conductor patterns K11 to K14 of the inductor L11 are superimposed parallel or substantially parallel to a first main surface 11 of the insulator 10, and are electrically connected to each other by a plurality of via conductors. The conductor patterns K15 to K18 of the inductor L12 are superimposed parallel or substantially parallel to the first main surface 11 of the insulator 10, and are electrically connected to each other by a plurality of via conductors. The inductor L11 is arranged on a second main surface 12 side of the inductor L12.

The conductor patterns K15 to K18 of the inductor L12 are superimposed on each other with an insulating layer interposed therebetween below the conductor patterns K11 to K14 of the inductor L11 in the Z direction. That is, the inductor L12 is arranged on the first main surface 11 side of the inductor L11. The electrode patterns K19 and K20 of the capacitor C11 are superimposed on each other with an insulating layer interposed therebetween below the conductor patterns K15 to K18 of the inductor L12 in the Z direction. That is, the capacitor C11 is arranged on the first main surface 11 side of the inductor L11 and the inductor L12.

Specifically, the electronic component 300 includes insulating substrates N11 to N20 in this order from the second main surface 12 side. In the insulator 10, the conductor pattern and the electrode pattern are provided on the insulating substrates N11 to N20 by a printing method, for example.

The conductor pattern K11 as a portion of the inductor L11 is formed on the insulating substrate N11. The conductor pattern K11 is structured so as to make a rightward turn about ¾ of the way from the upper left side of the insulating substrate N11 in FIG. 11. The beginning of the conductor pattern K11 is electrically connected to a second electrode 31b of a first outer electrode 31. A connection portion P11 that connects to a via conductor V11A and a connection portion P12 that connects to a via conductor V11B are provided in the vicinity of the end of the conductor pattern K11.

The conductor pattern K12 as a portion of the inductor L11 is provided on the insulating substrate N12. The conductor pattern K12 is structured so as to make a rightward turn about ¾ of the way from the upper left side of the insulating substrate N12 in FIG. 11. The beginning of the conductor pattern K12 is electrically connected to the second electrode 31b of the first outer electrode 31. A connection portion P13 that connects to via conductors V11A and V12A and a connection portion P14 that connects to via conductors V11B and V12B are provided in the vicinity of the end of the conductor pattern K12.

The conductor pattern K13 as a portion of the inductor L11 is provided on the insulating substrate N13. The conductor pattern K13 is structured so as to make a rightward turn about ¾ of the way from the lower right side of the insulating substrate N13 in FIG. 11. A connection portion P15 that connects to via conductors V12A and V13A and a connection portion P16 that connects to via conductors V12B and V13B are provided in the vicinity of the beginning of the conductor pattern K13. The end of the conductor pattern K13 is electrically connected to a fifth electrode 32b of a second outer electrode 32.

The conductor pattern K14 as a portion of the inductor L11 is provided on the insulating substrate N14. The conductor pattern K14 is structured so as to make a rightward turn about ¾ of the way from the lower right side of the insulating substrate N14 in FIG. 11. A connection portion P17 that connects to the via conductor V13A and a connection portion P18 that connects to the via conductor V13B are provided in the vicinity of the beginning of the conductor pattern K14. The end of the conductor pattern K14 is electrically connected to the fifth electrode 32b of the second outer electrode 32.

As described above, the inductor L11 defines a coil by parallel connection of the conductor pattern K11 and the conductor pattern K12, parallel connection of the conductor pattern K13 and the conductor pattern K14, and series connection of the conductor patterns K11 and K12 and the conductor patterns K13 and K14.

The conductor pattern K15 as a portion of the inductor L12 is provided on the insulating substrate N15. The conductor pattern K15 is structured so as to make a leftward turn from the upper left side of the insulating substrate N15 in FIG. 11. The beginning of the conductor pattern K15 is electrically connected to the second electrode 31b of the first outer electrode 31. A connection portion P19 that connects to a via conductor V14 is provided in the vicinity of the end of the conductor pattern K15.

The conductor pattern K16 as a portion of the inductor L12 is provided on the insulating substrate N16. The conductor pattern K16 is structured so as to make a leftward turn from the upper left side of the insulating substrate N16 in FIG. 11. The beginning of the conductor pattern K16 is electrically connected to the second electrode 31b of the first outer electrode 31. A connection portion P20 that connects to via conductors V14 and V15 is provided in the vicinity of the end of the conductor pattern K16.

The conductor pattern K17 as a portion of the inductor L12 is provided on the insulating substrate N17. The conductor pattern K17 is structured so as to make a leftward turn from the upper side of the insulating substrate N17 in FIG. 11. A connection portion P21 that connects to via conductors V15 and V16A is provided in the vicinity of the beginning of the conductor pattern K17. A connection portion P22 that connects to a via conductor V16B is provided in the vicinity of the end of the conductor pattern K17.

The conductor pattern K18 as a portion of the inductor L12 is provided on the insulating substrate N18. The conductor pattern K18 is structured so as to make a leftward turn from the upper side of the insulating substrate N18 in FIG. 11. A connection portion P23 that connects to the via conductor V16A is provided in the vicinity of the beginning of the conductor pattern K18. A connection portion P24 that connects to via conductors V16B and V17 is provided in the vicinity of the end of the conductor pattern K18.

As described above, the inductor L12 defines a coil by parallel connection of the conductor pattern K15 and the conductor pattern K16, parallel connection of the conductor pattern K17 and the conductor pattern K18, and also series connection of the conductor patterns K15 and K16 and the conductor patterns K17 and K18.

An electrode pattern K19 defining the other electrode of the capacitor C11 is provided on the insulating substrate N19. In plan view of the electrode pattern K19 viewed from the second main surface 12 side, the electrode pattern K19 is provided in a position overlapping a portion of the conductor patterns K17 and K18 in the lamination direction (Z direction). That is, the electrode pattern K19 is provided in a position where the region overlapping the cavity of the inductor L12 including the conductor patterns K17 and K18 is reduced. A connection portion P25 that connects to the via conductor V17 is provided in the electrode pattern K19. That is, the electrode pattern K19 is connected to the connection portion P24 of the conductor pattern K18 of the inductor L12 by the via conductor V17.

An electrode pattern K20 defining the other electrode of the capacitor C11 is provided on the insulating substrate N20. In plan view of the electrode pattern K20 viewed from the second main surface 12 side, the electrode pattern K20 is provided in a position overlapping a portion of the conductor patterns K17 and K18 in the lamination direction (Z direction). That is, the electrode pattern K20 is provided in a position where the region overlapping the cavity of the inductor L12 including the conductor patterns K17 and K18 is reduced. A connection portion P26 that connects to a via conductor V18 is provided in the electrode pattern K20. The connection portion P26 of the electrode pattern K20 is connected to a connection portion P28 provided in a fourth electrode 32a by the via conductor V18. The electrode pattern K20 is electrically connected to the fifth electrode 32b and a sixth electrode 32c of the second outer electrode 32.

As described above, a chip component small filter device that defines a resonant circuit such as the electronic component 300 according to Example Embodiment 3, as well, may electrically connect a first electrode 31a and a second electrode 31b by an internal conductor SL1 provided in the insulator 10.

Specifically, in the electronic component the internal conductor SL1 is provided on the same insulating substrate N20 as the electrode pattern K20 defining the capacitor C11. The internal conductor SL1 is provided at a position overlapping a portion of the conductor pattern K18 in the lamination direction (Z direction) and extends in the same direction (X direction) as a portion of the conductor pattern K18 of the inductor L12. The current flowing through the internal conductor SL1 is parallel or substantially parallel and opposite to the current flowing through the portion of the conductor pattern K18 adjacent to the internal conductor SL1. The internal conductor SL1 and the conductor pattern K18 are in magnetic field coupling (subtractive polarity coupling) with each other.

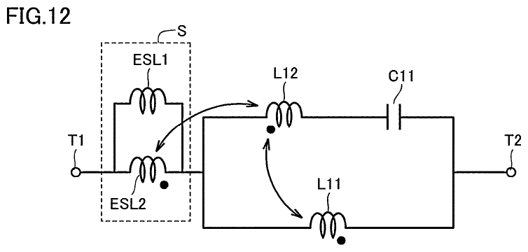

FIG. 12 is an equivalent circuit diagram of the electronic component according to Example Embodiment 3. As illustrated in FIG. 12, the electronic component 300 according to Example Embodiment 3 includes a first terminal T1, an ESL unit S connected to the first terminal T1, the inductor L12 connected to the ESL unit S, the capacitor C11 connected in series with the inductor L12, and a second terminal T2 connected to the capacitor C11. The electronic component 300 further includes the inductor L11 connected in parallel with the inductor L12 and the capacitor C11. The ESL unit S includes a parasitic inductance ESL1 and a parasitic inductance ESL2 connected in parallel. The first terminal T1 corresponds to a connection point in a mounting substrate of the first outer electrode 31 and the second terminal T2 corresponds to a connection point in the mounting substrate of the second outer electrode 32.

The inductor L11 and the inductor L12 are in magnetic field coupling with each other. Additionally, the conductor pattern K18 of the inductor L12 and the internal conductor SL1 are in magnetic field coupling with each other.

As described above, in the electronic component 300 according to Example Embodiment 3, the first electrode 31a and the second electrode 31b are not only electrically connected by the first path passing through the outer periphery of the insulator 10, but also electrically connected by the second path passing through the internal conductor SL1 in the insulator 10. As a result, in a chip component small filter device defining a resonant circuit such as the electronic component 300 of Example Embodiment 3, as well even if the electrical connection between the first electrode 31a and the second electrode 31b is broken in the first path passing through the outer periphery of the insulator 10, the electrical connection between the first electrode 31a and the second electrode 31b can be maintained in the second path passing through the internal conductor SL1 in the insulator 10. Thus, a change in electrical characteristics due to the disconnection of the first outer electrode 31 can be reduced or prevented.

### Example Embodiment 4

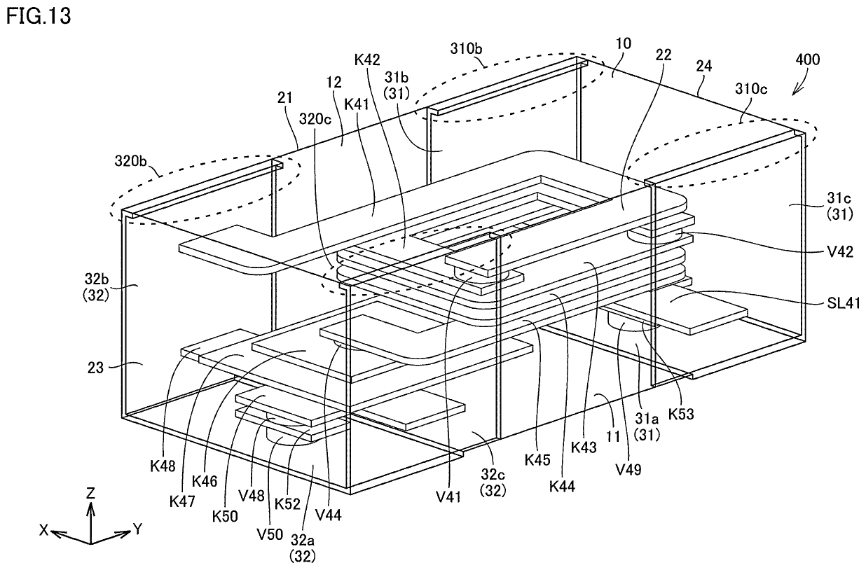

An electronic component 400 according to Example Embodiment 4 of the present invention will be described with reference to FIGS. 13 to 18. For the electronic component 400 according to Example Embodiment 4, only configurations different from the electronic component 100 according to Example Embodiment 1, the electronic component 200 according to Example Embodiment 2, and the electronic component 300 according to Example Embodiment 3 will mainly be described, and the same or substantially the same configurations as the electronic component 100 according to Example Embodiment 1, the electronic component 200 according to Example Embodiment 2, and the electronic component 300 according to Example Embodiment 3 are denoted by the same reference signs in the electronic component 400 according to Example Embodiment 4, and descriptions thereof are omitted.

FIG. 13 is a perspective view of the electronic component 400 according to Example Embodiment 4. A first outer electrode 31 and a second outer electrode 32 of the electronic component 400 according to Example Embodiment 4 illustrated in FIG. 13 and the first outer electrode 31 and the second outer electrode 32 of the electronic component 100 according to Example Embodiment 1 illustrated in FIG. 1 are located in contrasting positions in the Y direction.

Specifically, as illustrated in FIG. 13, the first outer electrode 31 is provided on a fourth side surface 24 side of the second outer electrode 32 in the longitudinal direction (Y direction) of the insulator 10. The second outer electrode 32 is provided on a third side surface 23 side of the first outer electrode 31 in the longitudinal direction (Y direction) of the insulator 10.

The first outer electrode 31 has a first electrode 31a provided along a first main surface 11, a second electrode 31b provided along a first side surface 21, and a third electrode 31c provided along a second side surface 22. The second outer electrode 32 has a fourth electrode 32a provided along the first main surface 11, a fifth electrode 32b provided along the first side surface 21, and a sixth electrode 32c provided along the second side surface 22.

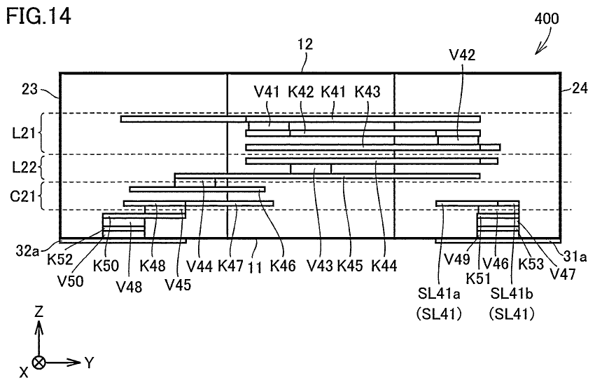

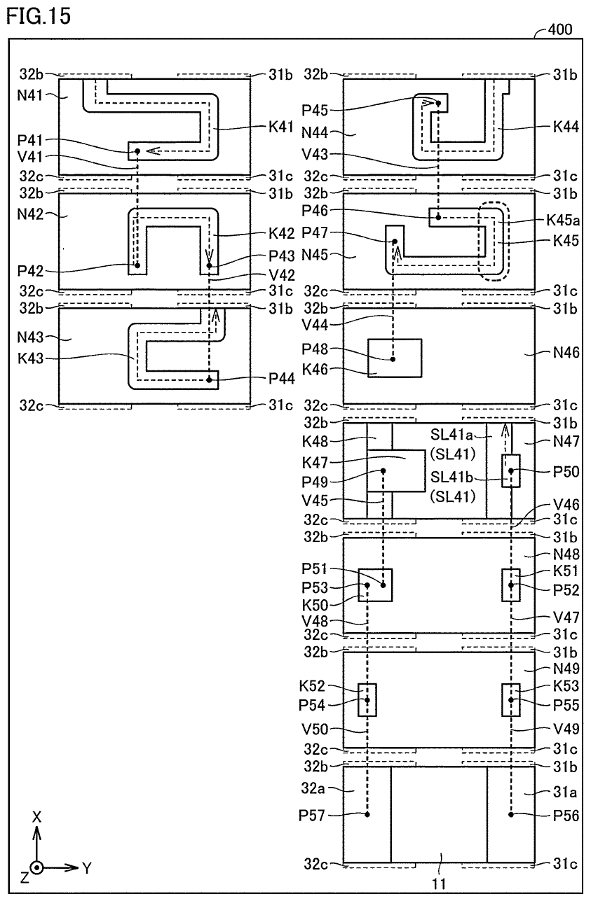

FIG. 14 is a cross-sectional view illustrating the configuration of the inside of the insulator 10 of the electronic component 400 according to Example Embodiment 4. FIG. 15 is an exploded plan view illustrating the configuration of the electronic component 400 according to Example Embodiment 4. As illustrated in FIGS. 13 to 15, the electronic component 400 is a chip component small filter device in which an inductor L22 and a capacitor C21 are connected in series and the inductor L22 and the capacitor C21 are connected in parallel with an inductor L21.

Specifically, the electronic component 400 includes, in the insulator 10, the inductor L21 including conductor patterns K41 to K43, the inductor L22 including conductor patterns K44 and K45, and the capacitor C21 including electrode patterns K46 and K47. By connecting the inductor L22 and the capacitor C21 in series and connecting the inductor L22 and the capacitor C21 in parallel with the inductor L21 in the insulator 10, the electronic component 400 forms a resonant circuit. In the electronic component 400 according to Example Embodiment 4, the conductor pattern K45 is one example of “first conductor pattern”. In addition, in the electronic component 400 according to Example Embodiment 4, the inductor L22 is one example of “inductor” and the inductor L21 is one example of “another inductor”.

The conductor patterns K41 to K43 of the inductor L21

are superimposed parallel or substantially parallel to the first main surface 11 of the insulator 10, and are electrically connected to each other by a plurality of via conductors. The conductor patterns K44 and K45 of the inductor L22 are superimposed parallel or substantially parallel to the first main surface 11 of the insulator 10, and are electrically connected to each other by a plurality of via conductors. The inductor L21 is arranged on a second main surface 12 side of the inductor L22.

The conductor patterns K44 and K45 of the inductor L22 are superimposed on each other with an insulating layer interposed therebetween below the conductor patterns K41 to K43 of the inductor L21 in the Z direction. That is, the inductor L22 is arranged on the first main surface 11 side of the inductor L21. The electrode patterns K46 and K47 of the capacitor C21 are superimposed on each other with an insulating layer interposed therebetween below the conductor patterns K44 and K45 of the inductor L22 in the Z direction. That is, the capacitor C21 is arranged on the first main surface 11 side of the inductor L21 and the inductor L22.

Specifically, the electronic component 400 includes insulating substrates N41 to N49 in this order from the second main surface 12 side. In the insulator 10, the conductor pattern and the electrode pattern are provided on the insulating substrates N41 to N49 by, for example, a printing method.

The conductor pattern K41 as a portion of the inductor L21 is provided on the insulating substrate N41. The conductor pattern K41 is structured so as to make a rightward turn about ¾ of the way from the upper left side of the insulating substrate N41 in FIG. 15. The beginning of the conductor pattern K41 is electrically connected to the fifth electrode 32b of the second outer electrode 32. A connection portion P41 that connects to a via conductor V41 is provided in the vicinity of the end of the conductor pattern K41.

The conductor pattern K42 as a portion of the inductor L21 is provided on the insulating substrate N42. The conductor pattern K42 is structured so as to make a rightward turn about ¾ of the way from the lower left side of the insulating substrate N42 in FIG. 15. A connection portion P42 that connects to the via conductor V41 is provided in the vicinity of the beginning of the conductor pattern K42. A connection portion P43 that connects to a via conductor V42 is provided in the vicinity of the end of the conductor pattern K42.

The conductor pattern K43 as a portion of the inductor L21 is provided on the insulating substrate N43. The conductor pattern K43 is structured so as to make a leftward turn about ¾ of the way from the lower right side of the insulating substrate N43 in FIG. 15. A connection portion P44 that connects to the via conductor V42 is provided in the vicinity of the beginning of the conductor pattern K43. The end of the conductor pattern K43 is electrically connected to the second electrode 31b of the second outer electrode 32.

As described above, the inductor L21 defines a coil by series connection of the conductor pattern K41, the conductor pattern K42, and the conductor pattern K43.

The conductor pattern K44 as a portion of the inductor L22 is provided on the insulating substrate N44. The conductor pattern K44 is structured so as to make a rightward turn about ¾ of the way from the upper right side of the insulating substrate N44 in FIG. 15. The beginning of the conductor pattern K44 is electrically connected to the second electrode 31b of the first outer electrode 31. A connection portion P45 that connects to a via conductor V43 is provided in the vicinity of the end of the conductor pattern K44.

The conductor pattern K45 as a portion of the inductor L22 is provided on the insulating substrate N45. The conductor pattern K45 is structured so as to make a rightward turn about ¾ of the way from the upper side of the insulating substrate N45 in FIG. 15. The conductor pattern K45 includes a straight linear conductor pattern K45a between the second electrode 31b and the third electrode 31c. A connection portion P46 that connects to the via conductor V43 is provided in the vicinity of the beginning of the conductor pattern K45. A connection portion P47 that connects to a via conductor V44 is provided in the vicinity of the end of the conductor pattern K45.

As described above, the inductor L22 defines a coil by series connection of the conductor pattern K44, and the conductor pattern K45.

The electrode pattern K46 defining one electrode of the capacitor C21 is provided on the insulating substrate N46. In plan view of the electrode pattern K46 viewed from the second main surface 12 side, the electrode pattern K46 is provided in a position where the region overlapping the cavity of the inductors L21 and L22 in the lamination direction (Z direction) is reduced. As a result, a small filter device (electronic component 400) can be obtained without obstructing the magnetic field produced by the inductors L21 and L22. A connection portion P48 that connects to the via conductor V44 is provided in the electrode pattern K46. That is, the electrode pattern K46 is connected to the connection portion P47 of the conductor pattern K45 of the inductor L22 by the via conductor V44.

The electrode pattern K47 defining the other electrode of the capacitor C21 is provided on the insulating substrate N47. In plan view of the electrode pattern K47 viewed from the second main surface 12 side, the electrode pattern K47 is provided in a position overlapping the electrode pattern K46 in the lamination direction (Z direction). A connection portion P49 that connects to a via conductor V45 is provided in the electrode pattern K47. The electrode pattern K47 is electrically connected to the fifth electrode 32b and the sixth electrode 32c of the second outer electrode 32 via a wiring pattern K48. The wiring pattern K48 is not limited to a single wire overlapping the electrode pattern K47, and may include a plurality of wiring patterns.

Furthermore, in the electronic component 400, an internal conductor SL41 is provided on the same insulating substrate N47 as the electrode pattern K47 defining the capacitor C21. The internal conductor SL41 includes an internal conductor SL41a and an internal conductor SL41b. The internal conductor SL41a and the internal conductor SL41b are electrically connected by partially overlapping each other. A connection portion P50 that connects to a via conductor V46 is provided in the internal conductor SL41b.

The internal conductor SL41a includes a straight, linear conductor portion connecting the second electrode 31b and the third electrode 31c. The linear conductor portion of the internal conductor SL41a includes a layer of conductive body extending in the same direction (X direction) as the linear conductor pattern K45a of the inductor L22. In plan view of the conductor pattern K45 and the internal conductor SL41a viewed from the second main surface 12 side, the linear conductor portion of the internal conductor SL41a is provided in a position overlapping the linear conductor pattern K45a of the conductor pattern K45. Moreover, the current flowing through the internal conductor SL41 is parallel or substantially parallel and opposite to the current flowing through the portion (linear conductor pattern K45a) of the conductor pattern K45 adjacent to the internal conductor SL41a. The internal conductor SL41 and the conductor pattern K45 (linear conductor pattern K45a) are in magnetic field coupling (subtractive polarity coupling) with each other.

A wiring pattern K50 is provided on the insulating substrate N48. In plan view of the wiring pattern K50 viewed from the second main surface 12 side, the wiring pattern K50 is provided in a position overlapping a portion of the electrode pattern K47 in the lamination direction (Z direction). A connection portion P51 that connects to a via conductor V45 is provided in the wiring pattern K50. That is, the wiring pattern K50 is connected to the connection portion P49 of the electrode pattern K47 of the capacitor C21 by the via conductor V45. In addition, a connection portion P53 connecting to a via conductor V48 is provided in the wiring pattern K50.

Furthermore, a wiring pattern K51 is provided on the insulating substrate N48. In plan view of the wiring pattern K51 viewed from the second main surface 12 side, the wiring pattern K51 is provided in a position overlapping the internal conductor SL41b in the lamination direction (Z direction). A connection portion P52 that connects to a via conductor V46 and a via conductor V47 is provided in the wiring pattern K51. That is, the wiring pattern K51 is connected to the connection portion P50 of the internal conductor SL41b by the via conductor V46.

A wiring pattern K52 is provided on the insulating substrate N49. In plan view of the wiring pattern K52 viewed from the second main surface 12 side, the wiring pattern K52 is provided in a position overlapping a portion of the wiring pattern K50 in the lamination direction (Z direction). A connection portion P54 that connects to a via conductor V48 and a via conductor V50 is provided in the wiring pattern K52. That is, the wiring pattern K52 is connected to the connection portion P53 of the wiring pattern K50 by the via conductor V48. The wiring pattern K52 is connected to the connection portion P57 provided in the fourth electrode 32a by the via conductor V50.

Furthermore, a wiring pattern K53 is formed on the insulating substrate N49. In plan view of the wiring pattern K53 viewed from the second main surface 12 side, the wiring pattern K53 is provided in a position overlapping a portion of the wiring pattern K51 in the lamination direction (Z direction). A connection portion P55 that connects to the via conductor V47 and a via conductor V49 is provided in the wiring pattern K53. That is, the wiring pattern K53 is connected to the connection portion P52 of the wiring pattern K51 by the via conductor V47. The wiring pattern K53 is connected to a connection portion P56 provided in the first electrode 31a by the via conductor V49.

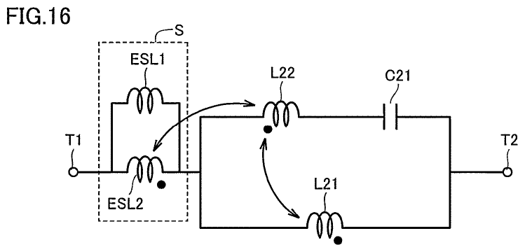

FIG. 16 is an equivalent circuit diagram of the electronic component 400 according to Example Embodiment 4. As illustrated in FIG. 16, the electronic component 400 according to Example Embodiment 4 includes a first terminal T1, an ESL unit S connected to the first terminal T1, the inductor L22 connected to the ESL unit S, the capacitor C21 connected in series with the inductor L22, and a second terminal T2 connected to the capacitor C21. The electronic component 400 further includes the inductor L21 connected in parallel with the inductor L22 and the capacitor C21. The ESL unit S includes a parasitic inductance ESL1 and a parasitic inductance ESL2 connected in parallel. The first terminal T1 corresponds to a connection point in a mounting substrate of the first outer electrode 31 and the second terminal T2 corresponds to a connection point in the mounting substrate of the second outer electrode 32.

The inductor L21 and the inductor L22 are in magnetic field coupling with each other. Additionally, the conductor pattern K45 of the inductor L22 and the internal conductor SL41 are in magnetic field coupling with each other.

As described above, in the electronic component 400 according to Example Embodiment 4, the first electrode 31a and the second electrode 31b are not only electrically connected by the first path passing through the outer periphery of the insulator 10, but also electrically connected by the second path passing through the internal conductor SL41 in the insulator 10. As a result, in a chip component small filter device defining a resonant circuit such as the electronic component 400 of Example Embodiment 4, as well, even if the electrical connection between the first electrode 31a and the second electrode 31b is broken in the first path passing through the outer periphery of the insulator 10, the electrical connection between the first electrode 31a and the second electrode 31b can be maintained in the second path passing through the internal conductor SL41 in the insulator 10. Thus, a change in electrical characteristics due to the disconnection of the first outer electrode 31 can be reduced or prevented.

Additionally, in the electronic component 400 according to Example Embodiment 4, as in the electronic component 300 according to Example Embodiment 3, the internal conductor SL41 is connected to the first electrode 31a provided on the first main surface 11 and also connected to the second electrode 31b provided on the first side surface 21. Moreover, in the electronic component 400, unlike the electronic component 300, the internal conductor SL41 is also connected to the third electrode 31c provided on the second side surface 22. Furthermore, the internal conductor SL41 extends in the same direction (X direction) as the conductor pattern K45 of the inductor L22 and is provided in a position overlapping the conductor pattern K45 in plan view of the conductor pattern K45 and the internal conductor SL41 when viewed from the second main surface 12 side. Then, as illustrated in FIG. 15, the inductor L11 or the inductor L12 is connected to the second electrode 31b, such that in the internal conductor SL41, current flows from the first electrode 31a via the wiring pattern K53 and the wiring pattern K51 to the second electrode 31b side via the connection portion P50. That is, in the internal conductor SL41, the current from the first electrode 31a flows to the second electrode 31b side instead of to the third electrode 31c side. As a result, the current flowing through the internal conductor SL41 is parallel or substantially parallel and opposite to the current flowing through the linear conductor pattern K45a of the conductor pattern K45, and the internal conductor SL41 and the conductor pattern K45 are in magnetic field coupling (subtractive polarity coupling) with each other.

Consequently, even if the linear conductor pattern K45a of the conductor pattern K45 is displaced in the X direction between the second electrode 31b provided on the first side surface 21 and the third electrode 31c provided on the second side surface 22, the area where the internal conductor SL41 and the conductor pattern K45 overlap in the lamination direction (Z direction) does not change.

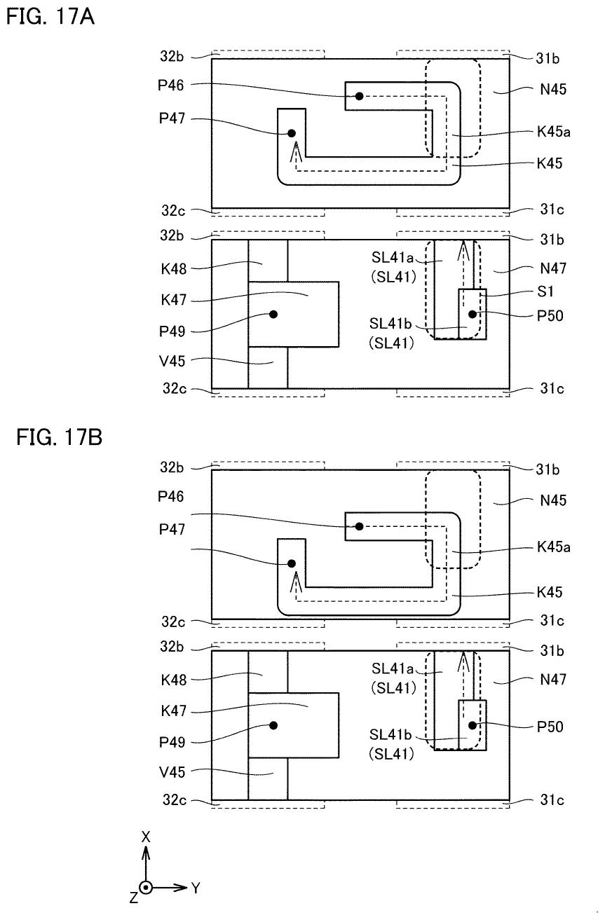

For example, FIGS. 17A and 17B are diagrams for describing displacement of the conductor pattern of the electronic component according to a comparative example. As illustrated in FIGS. 17A and 17B, when the internal conductor SL41 is not connected to the third electrode 31c, if the conductor pattern K45 is displaced in the X direction as illustrated in FIG. 17B from the state illustrated in FIG. 17A, the area where the internal conductor SL41 and the linear conductor pattern K45a of the conductor pattern K45 overlap in the lamination direction (Z direction) becomes smaller.

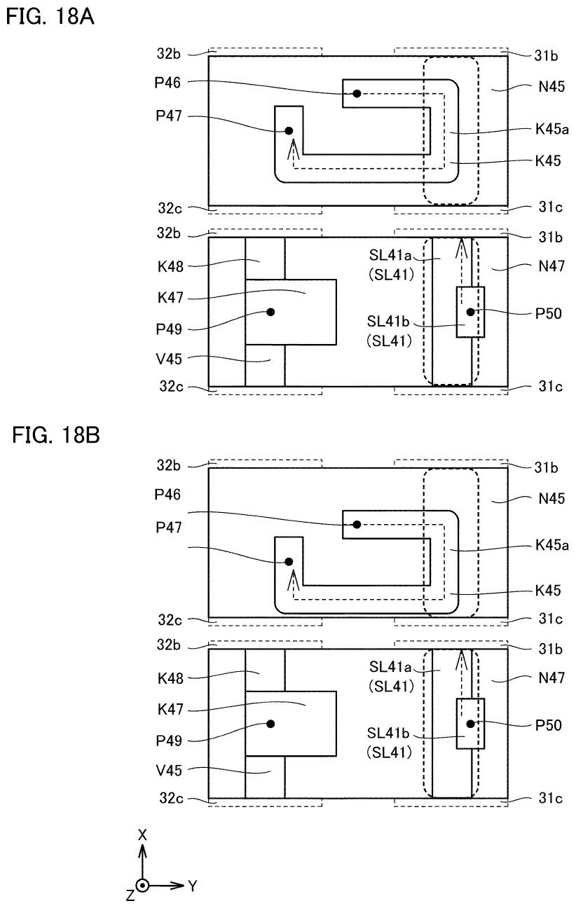

In contrast, FIGS. 18B are diagrams for describing displacement of the conductor pattern K45 of the electronic component 400 according to Example Embodiment 4. When the internal conductor SL41 is connected to the third electrode 31c as illustrated in FIGS. 18A and 18B, even if the conductor pattern K45 is displaced in the X direction from the state illustrated in FIG. 18A to the state illustrated in FIG. 18B, the area where the internal conductor SL41 and the linear conductor pattern K45a of the conductor pattern K45 overlap in the lamination direction (Z direction) does not easily change. As a result, the electronic component 400 can maintain the same or substantially the same magnetic field coupling (subtractive polarity coupling) between the internal conductor SL41 and the conductor pattern K45. Thus, a change in electrical characteristics due to disconnection of the first outer electrode 31 can be reduced or prevented because the magnetic field coupling (subtractive polarity coupling) between the internal conductor SL41 and the conductor pattern K45 remains substantially unchanged.

Furthermore, in the electronic component 400 according to Example Embodiment 4, the internal conductor SL41 is connected to the second electrode 31b provided on the first side surface 21 and also to the third electrode 31c provided on the second side surface 22. Hence, heat can be dissipated not only to the first side surface 21 but also to the second side surface 22, thereby improving heat dissipation.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An electronic component comprising:
an insulator;
an inductor provided in the insulator and including a first conductor pattern; and
an outer electrode electrically connected to the first conductor pattern; wherein
the insulator includes a first main surface, a second main surface facing the first main surface, and a first side surface, a second side surface, a third side surface, and a fourth side surface connecting the first main surface and the second main surface to one another;
the first side surface faces the second side surface;
the third side surface faces the fourth side surface;
the outer electrode includes a first electrode provided along the first main surface and a second electrode provided along the first side surface; and
the electronic component further includes an internal conductor provided in the insulator and electrically connecting the first electrode and the second electrode.

2. The electronic component according to claim 1, wherein the second electrode is electrically connected to the first electrode.

3. The electronic component according to claim 1, wherein the internal conductor is magnetic field coupled with the first conductor pattern.

4. The electronic component according to claim 1, wherein the internal conductor includes a portion where a current flowing through the internal conductor is opposite to a current flowing through an adjacent portion of the first conductor pattern closest to the internal conductor.

5. The electronic component according to claim 4, wherein the adjacent portion of the first conductor pattern is parallel or substantially parallel to the internal conductor.

6. The electronic component according to claim 1, wherein the internal conductor overlaps the first conductor pattern when viewed from the second main surface side.

7. The electronic component according to claim 1, wherein the outer electrode further includes a third electrode provided along the second side surface and electrically connected to the first electrode.

8. The electronic component according to claim 7, wherein the internal conductor also electrically connects the first electrode and the third electrode.

9. The electronic component according to claim 8, wherein the internal conductor includes a layer of a conductor body connecting the second electrode and the third electrode.

10. The electronic component according to claim 8, wherein the internal conductor includes a straight linear conductor portion connecting the second electrode and the third electrode.

11. The electronic component according to claim 10, wherein the first conductor pattern includes a straight linear conductor pattern between the second electrode and the third electrode; and
the linear conductor portion of the internal conductor overlaps the linear conductor pattern of the first conductor pattern when viewed from the second main surface side.

12. The electronic component according to claim 1, wherein the first main surface is a surface located on a mounting substrate.

13. The electronic component according to claim 1, further comprising a capacitor connected in series with the inductor in the insulator.

14. The electronic component according to claim 13, wherein one electrode pattern defining the capacitor is provided on a same plane as a portion of the internal conductor.

15. The electronic component according to claim 13, further comprising another inductor connected in parallel or substantially in parallel with the inductor in the insulator.

16. The electronic component according to claim 15, wherein the another inductor is magnetic field coupled with the inductor.

17. The electronic component according to claim 1, wherein the insulator includes at least one of a borosilicate glass, alumina, zirconia, or polyimide resin as a main component.

18. The electronic component according to claim 1, wherein each of the first electrode and second electrode has a recessed or substantially recessed shape.

19. The electronic component according to claim 1, wherein the inductor is defined by a coil.

20. The electronic component according to claim 19, wherein the coil includes a plurality of conductor patterns serially connected to each other.
